(19) United States
(12) Patent Application Publication
(10) Pub. No.: US 2025/0168941 A1
(43) Pub. Date: May 22, 2025

(54) HEATING COIL FOR HIGH-FREQUENCY HEATER

(71) Applicant: TKE Co.,Ltd, Yatomi-shi, Aichi (JP)

(72) Inventors: Hideaki ITO, Yatomi-shi, Aichi (JP); Kazuhiro ABE, Yatomi-shi, Aichi (JP)

(21) Appl. No.: 18/839,417

(22) PCT Filed: Mar. 30, 2022
(86) PCT No.: PCT/JP2022/016286

§ 371 Date: Aug. 16, 2024

(30) Foreign Application Priority Data
Feb. 17, 2022 (JP) 2022-023319

(51) Int. Cl. H05B 6/42; B33Y 80/00; C21D 9/00; H05B 6/10

(52) U.S. Cl. CPC H05B 6/42; B33Y 80/00; C21D 9/00; H05B 6/101

(57) ABSTRACT

A heating coil (1) is integrally formed by a modeling method of repeating laying, melting, solidifying, and laminating of a powder containing a conductive material based on three-dimensional data. The heating coil includes grounding portions (2a, 2b) for contact with an electrode, supporting portions (3a, 3b) disposed to be perpendicular to the respective grounding portions (2a, 2b), and a heating unit (4) disposed to connect distal ends of the supporting portions (3a, 3b) to one another. Contact portions (20a, 20b) above a forming portion (bulging portion 5) of cooling medium flow-down paths (18a, 18b) of the supporting portions (3a, 3b) is thinner than a forming portion of the cooling medium flow-down paths (18a, 18b).

### TECHNICAL FIELD

The present invention relates to a heating coil used for a high-frequency heater configured to heat a material to be worked using electromagnetic induction by a high-frequency current.

### BACKGROUND ART

For increasing hardness of a portion close to a surface of a metal material to be worked (workpiece), processing (what is called, a hardening process) in which the surface of the material to be worked is heated to a temperature equal to or more than a transformation point (austenite transformation point) of the metal and then rapidly cooled is performed. As a method for performing the hardening process, a method in which a material to be worked is heated by bringing a metal member (heating coil) to which a high-frequency current has been flowed close to a surface of the material to be worked using a high-frequency heater is widely employed.

A conventional heating coil includes a pair of grounding portions that are grounded to a high-frequency power supply, an annular coil portion configured to be fitted externally to a material to be worked, and a pair of coupling portions configured to couple the grounding portions to the coil portion. Additionally, to suppress heat generation when a high-frequency current is flowed, the conventional heating coil is provided with a coolant passage for flowing down a medium for cooling, such as water, to the coil portion. For example, Patent Document 1 discloses a heating coil in which a coolant passage is formed inside a coil portion by laminating a coil plate with a depressed groove engraved to an inner surface.

Furthermore, in a general heating coil, to avoid occurrence of dielectric breakdown between a pair of grounding portions and between a pair of coupling portions disposed side by side when the output of a high-frequency power supply is increased, an insulating plate made of synthetic resin is interposed between the pair of grounding portions and between the pair of coupling portions (Patent Document 2).

Patent Document 1: Japanese Patent No. 4358292

Patent Document 2: Japanese Unexamined Patent Application Publication No. 2020-115428

### DISCLOSURE OF THE INVENTION

### Problems to Be Solved by the Invention

However, the conventional heating coil for a high-frequency heater described above needs to be formed by bonding a plurality of components with silver solder or the like to provide a hollow coolant passage in the coil portion. Therefore, continuous use under a high output condition (under a processing condition of applying a high-frequency power supply of a high voltage) easily causes damage, leading to a situation in which a cooling medium leaks out. Additionally, the conventional heating coil for a high-frequency heater is poor in cooling efficiency because a cooling mechanism is disposed only at the coil portion, and has a problem that the continuous use under the high output condition causes the insulating plate to carbonize and deteriorate due to the grounding portions and the coupling portions maintained at a high temperature, causing dielectric breakdown by creeping discharge.

Furthermore, since the above-described conventional heating coil needs to be formed by brazing a plurality of components, it is difficult to manufacture products having the same characteristics with good reproducibility during manufacturing, and this causes a problem that variation occurs in the quality of a material to be worked to be heated. In addition, since the conventional heating coil for a high-frequency heater needs to be formed by bonding a plurality of components with silver solder or the like as described above, it is likely to become large and heavy, and this also causes a problem from the aspect of handling ability.

It is an object of the present invention to solve the above-described problems of the conventional heating coil for a high-frequency heater, and to provide a heating coil for a high-frequency heater that is excellent in cooling efficiency, can be continuously used for a long period of time without being damaged even under a high output condition, can be manufactured in the same characteristics with good reproducibility during manufacturing, is made lighter in weight, and has an excellent handling ability.

### Solutions to the Problems

The invention recited in claim 1 among the present invention is a heating coil used for a high-frequency heater configured to heat a material to be worked using electromagnetic induction by a high-frequency current. The heating coil for a high-frequency heater is integrally formed by a modeling method of repeating laying, melting, solidifying, and laminating of a powder containing a conductive material based on three-dimensional data (hereinafter referred to as a partial welding lamination method of conductive material powder layer), or a modeling method of laminating a melted conductive material based on three-dimensional data (hereinafter referred to as a melt extrusion lamination method of conductive material). The heating coil includes a pair of plate-shaped grounding portions for contact with an electrode through which a high-frequency current is flowed, a pair of plate-shaped supporting portions disposed to be perpendicular to the respective grounding portions, and a sequence of circumferential heating unit disposed to connect distal ends of the supporting portions to one another. A cooling medium flow-down path for flowing down a medium for cooling is formed inside each of the supporting portions, and the cooling medium flow-down path is communicated with a cooling medium flow-down path formed inside the heating unit. A portion other than a forming portion of the cooling medium flow-down path in each of the supporting portion is thinner than the forming portion of the cooling medium flow-down path.

In the invention recited in claim 2, which is the invention recited in claim 1, the cooling medium flow-down path in each of the supporting portions has a long flat-shaped cross-sectional surface in a plate surface direction of each supporting portion.

In the invention recited in claim 3, which is the invention recited in claim 1 or 2, in the forming portion of the cooling medium flow-down path in each of the supporting portions, an inner portion of the cooling medium flow-down path is formed thicker than an outer portion of the cooling medium flow-down path.

In the invention recited in claim 4, which is the invention recited in any one of claims 1 to 3, a cooling medium flow-down path for flowing down a medium for cooling is formed inside each of the grounding portions, and the cooling medium flow-down path is communicated with the cooling medium flow-down path formed inside the supporting portion.

### Effects of the Invention

In the heating coil for a high-frequency heater (hereinafter simply referred to as a heating coil) according to claim 1, the cooling medium flow-down paths for flowing down the medium for cooling are formed inside the respective left and right supporting portions, and the cooling medium flow-down paths are communicated with the cooling medium flow-down path formed inside the heating unit (that is, a sequence of cooling medium flow-down path is formed in the heating unit and the supporting portions). Accordingly, a portion maintained at a high temperature over a long time is not generated. Therefore, since the situation, such as dielectric breakdown caused by carbonization and/or deterioration of an insulating plate and damage due to stress concentration to a specific part, is less likely to occur, the heating coil according to claim 1 is excellent in durability and can undergo repeated heat treatment to a material to be worked over a long period of time even under a high output condition. In addition, in the heating coil according to claim 1, the portion other than forming portion of the cooling medium flow-down path in each of the supporting portions is thinner than the forming portion of the cooling medium flow-down path. Accordingly, the heating coil can be inexpensively manufactured by reducing the material cost, is lightweight, and has excellent handling ability.

In addition, the heating coil according to claim 1 is formed by the partial welding lamination method of conductive material powder layer or the melt extrusion lamination method of conductive material based on three-dimensional data. Accordingly, the heating coil can be inexpensively and considerably easily manufactured even though the sequence of circumferential heating unit has a complicated shape that includes the sinking portions. Moreover, products having the same shape and the same characteristics can be efficiently manufactured with good reproducibility regardless of the skill of manufacturing workers. Furthermore, since the heating coil according to claim 1 is formed by the partial welding lamination method of conductive material powder layer or the melt extrusion lamination method of conductive material based on three-dimensional data, a bonding portion by silver solder, as in a conventional heating coil, is not present. Accordingly, deformation does not occur even when the temperature rises due to continuous use, and heat treatment (hardening treatment) according to specifications can be performed over a long period of time.

In the heating coil according to claim 2, since the cooling medium flow-down path in each of the supporting portions has a long flat-shaped cross-sectional surface in the plate surface direction of the respective supporting portions, a sufficient amount of medium for cooling can be flowed down in the cooling medium flow-down path. Accordingly, a material to be worked and the heating coil itself can be cooled highly efficiently.

In the heating coil according to claim 3, the forming portion of the cooling medium flow-down path in each of the supporting portions is formed such that an inner portion of the cooling medium flow-down path where an applied high-frequency current easily flows is thicker than an outer portion of the cooling medium flow-down path. Accordingly, the situation, such as dielectric breakdown caused by carbonization and/or deterioration of an insulating plate and damage due to stress concentration to a specific part, is extremely unlikely to occur, and very excellent durability can be exhibited.

In the heating coil according to claim 4, the sequence of cooling medium flow-down path for flowing down a medium for cooling is formed not only inside the sequence of circumferential heating unit but also inside each of the grounding portions and each of the supporting portions, and not only the heating unit but also the grounding portions and the supporting portions are simultaneously cooled during heat treatment of a material to be worked. Accordingly, a portion maintained at a high temperature over a long time is not generated. Therefore, since the situation, such as dielectric breakdown caused by carbonization and/or deterioration of an insulating plate and damage due to stress concentration to a specific part, is less likely to occur, the heating coil according to claim 4 is excellent in durability and can undergo the repeated heat treatment to a material to be worked over a long period of time even under a high output condition.

### BRIEF DESCRIPTION OF THE DRAWINGS

FIG. 1 is a perspective view of a heating coil (coil body).

FIG. 2 is a plan view of the heating coil (perspective plan view of cooling medium flow-down paths inside).

FIG. 3 is a right side view of the heating coil (perspective right side view of the cooling medium flow-down paths inside).

FIG. 4 is a front view of the heating coil.

FIG. 5 is a back view of the heating coil.

FIG. 6 is an explanatory view illustrating a vertical cross-sectional surface of supporting portions of the heating coil (FIG. 6(a) is a cross-sectional view of line A-A in FIG. 2, and FIG. 6(b) is an enlarged view of forming portions of cooling medium flow-down paths).

FIG. 7 is an explanatory view illustrating a vertical cross-sectional surface of a heating unit of the heating coil (cross-sectional view of line B-B in FIG. 2).

FIG. 8 is an explanatory view illustrating a horizontal cross-sectional surface of the heating coil (cross-sectional view of line C-C in FIG. 3).

FIG. 9 is an explanatory view illustrating a state of manufacturing the heating coil (FIG. 9(a) is a plan view, and FIG. 9(b) is a vertical cross-sectional view).

### DESCRIPTION OF PREFERRED EMBODIMENTS

A heating coil according to the present invention requires to be integrally formed by a modeling method based on three-dimensional data using a three-dimensional printer. As the modeling method, a modeling method of repeating laying, melting, solidifying, and laminating of a powder containing a conductive material based on three-dimensional data (partial welding lamination method of conductive material powder layer), or a modeling method of laminating a melted conductive material based on three-dimensional data (melt extrusion lamination method of conductive material) can be employed. The use of the partial welding lamination method of conductive material powder layer as the heating coil modeling method is preferable because a heating coil having a complicated shape and structure can be easily manufactured.

The conductive material used as a raw material of modeling in the present invention means a material that substantially does not have a magnetic property and has satisfactory conductivity. Examples of the conductive material can include copper, brass, and argentum. Among these conductive materials, use of copper is preferable because it allows a reduction in the cost, such as material cost and ensures inexpensively and easily manufacturing the heating coil by a three-dimensional printer, and it also makes the conductivity extremely satisfactory and improves heat generation efficiency by electromagnetic induction.

When copper is used as the conductive material, pure copper can be used. However, use of an alloy (high copper alloy) in which iron, tin, nickel, titanium, beryllium, zirconium, chrome, silicon, or the like is contained in copper with a lower proportion than copper is preferable because laser absorption is increased to allow accelerating temperature rise. Furthermore, among those copper alloys, use of a copper-chrome alloy in which chrome is contained in copper is more preferable because the strength of the heating coil can be effectively enhanced while the production efficiency with the three-dimensional printer is maintained to be high. Use of an alloy in which chrome and zirconium are contained in copper with predetermined proportions (for example, one (high copper alloy) containing 98.71 mass % to 99.45 mass % copper, 0.50 mass % to 1.00 mass % chrome, and 0.05 mass % to 0.25 mass % zirconium) is especially preferable.

When the partial welding lamination method of conductive material powder layer is used to model the heating coil according to the present invention, the laid raw material of modeling (that is, a powder containing a conductive material) needs to be melted by irradiation with a laser or electron beam. While a semiconductor laser, a carbon dioxide laser, an excimer laser, a YAG laser, a fiber laser, or the like can be appropriately used as the laser at that time, use of the fiber laser (that is, a laser that uses an optical fiber in which a rare earth element, such as Yb, is added as a laser medium) is preferable because a laser light without deviation of optical axis can be obtained at a high output by a small-sized device, and the heating coil with high dimensional accuracy can be considerably efficiently manufactured.

When the partial welding lamination method of conductive material powder layer is used to model the heating coil, the output and the wavelength of the fiber laser are not specifically limited. However, the adjustment of the output within a range of 400 W to 1,000 W and the adjustment of the wavelength within a range of 1,000 nm to 1,100 nm are preferable because efficient modeling in a short time can be performed. When copper (pure copper) is used as the conductive material, to improve the laser absorbance of copper powder for enhancing the production efficiency of the heating coil, an absorbent containing a mixed powder of graphite and an inorganic oxide, or the like can be added to the copper powder.

The heating coil according to the present invention needs to include a pair of plate-shaped grounding portions for contact with an electrode through which a high-frequency current is flowed, a pair of plate-shaped supporting portions disposed to be perpendicular to the respective grounding portions, and a sequence of circumferential heating unit disposed to connect distal ends of the supporting portions to one another. While the supporting portions are not specifically limited in shape insofar as they are a pair of plate-shaped (or rod-shaped) ones disposed to be perpendicular to the respective grounding portions, those with chamfered corner portions are preferable for avoiding a discharge phenomenon when an electric power is applied.

On the other hand, while the heating unit needs to be formed in a sequence of circumferential shape, the heating unit is not limited to a circular one, and may be one having a non-circular shape (for example, a rectangular ring shape in plan view), one having a shape forming a part of a circular ring (that is, an arc shape), one having a shape forming a part of a rectangular or polygonal ring, or the like. In addition, the heating unit may be, for example, one having a shape coupling a plurality of circular bodies, non-circular bodies (such as rectangular ring-shaped bodies in plan view), arc-shaped bodies, or shape bodies forming a part of a rectangular or polygonal ring, which are disposed one above the other, with one or a plurality of vertical columnar bodies or the like. In addition, the heating coil according to the present invention preferably includes at least one or more sinking portions (slit or the like having a predetermined length) to be formed in an inner peripheral edge of the sequence of circumferential heating unit so as to lie along a radiation direction from the center of the heating unit.

The sequence of circumferential heating unit needs to include a cooling medium flow-down path for cooling a material to be worked after heating and cooling the heating unit itself. Furthermore, in the cooling medium flow-down path, a plurality of spray holes for spraying a cooling medium to the material to be worked after heating can be provided. By providing the spray holes, the cooling efficiency of the material to be worked after heating can be further improved.

In the heating coil according to the present invention, a sequence of cooling medium flow-down paths for flowing down the medium for cooling needs to be formed inside the respective left and right supporting portions so as to be continuous with the cooling medium flow-down path inside the heating unit. Furthermore, the cooling medium flow-down paths inside the respective left and right supporting portions are preferably formed such that coupling portions to the heating unit do not bend in an up-down direction and preferably formed at positions where a high-frequency current applied from the grounding portions easily flows down.

In addition, in the heating coil according to the present invention, portions other than forming portions of the cooling medium flow-down paths in the respective supporting portions need to be formed thinner than the forming portions of the cooling medium flow-down paths. Thus, by forming the predetermined portions of the respective supporting portions (portions where a high-frequency current applied from the grounding portions is less likely to flow down) to be thinner, weight reduction can be ensured without causing excessive temperature rise of the supporting portions, allowing the heating coil to be inexpensively manufactured by reducing the material cost. Furthermore, when the cooling medium flow-down paths in the respective supporting portions have a long flat-shaped cross-sectional surface in a plate surface direction of the respective supporting portions (for example, have a vertically elongated elliptic cross-sectional surface), a large amount of medium for cooling can be flowed down in the cooling medium flow-down paths without forming the forming portions of the cooling medium flow-down paths in the supporting portions to bulge significantly outward.

Further, in the forming portion of the cooling medium flow-down path in each supporting portion, an inner portion of the cooling medium flow-down path is preferably formed thicker than an outer portion of the cooling medium flow-down path. In the forming portion of the cooling medium flow-down path in each supporting portion, an applied high-frequency current easily flows in the inner portion. Accordingly, by thus forming the inner portion to be thicker than the outer portion, the situation, such as dielectric breakdown caused by carbonization and/or deterioration of an insulating plate and damage due to stress concentration to a specific part, can be avoided more effectively.

Furthermore, in the heating coil according to the present invention, a sequence of cooling medium flow-down path for flowing down the medium for cooling is preferably formed inside the left and right respective grounding portions so as to be continuous with the cooling medium flow-down path inside the heating unit and the respective supporting portions. In addition, the cooling medium flow-down path formed without a seam or a level difference equal to or more than a predetermined height (1.0 mm or more) on an inner wall, or formed with a bent portion and a coupling portion in smooth curved shapes (curved shapes having a curvature radius of 5 mm or more) is preferable because the flow down aspect of the cooling medium becomes considerably smooth, and the cooling efficiency of the heating unit, the supporting portions, and the grounding portions of the heating unit becomes extremely satisfactory.

The heating coil according to the present invention is formed by the partial welding lamination method of conductive material powder layer or the melt extrusion lamination method of conductive material based on three-dimensional data. Accordingly, the heating coil can be considerably easily manufactured despite having a complicated shape as described above (that is, a shape in which the cooling medium flow-down paths are formed inside the respective left and right supporting portions so as to be communicated with the cooling medium flow-down path inside the heating unit and the portions other than the forming portions of the cooling medium flow-down paths in the respective supporting portions are thinner than the forming portions of the cooling medium flow-down paths).

### EXAMPLES

### Example 1

### Structure of Heating Coil

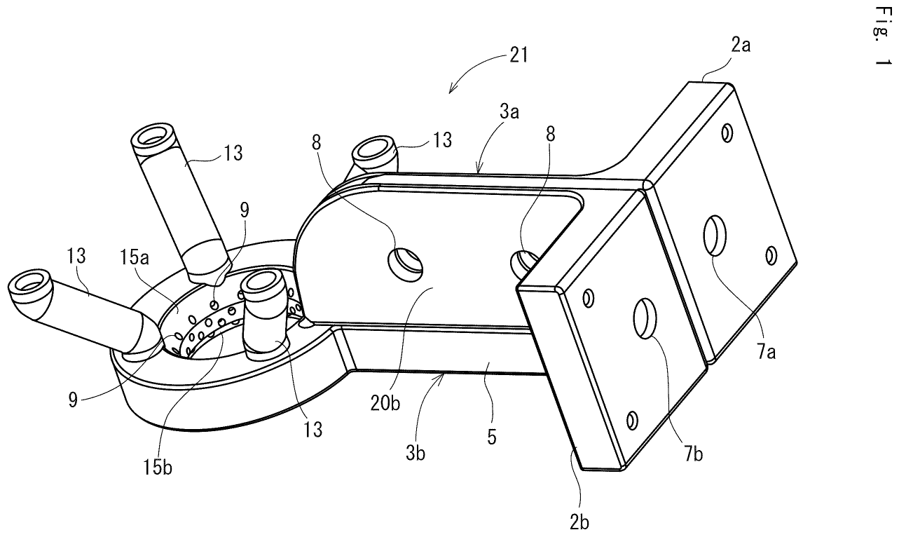

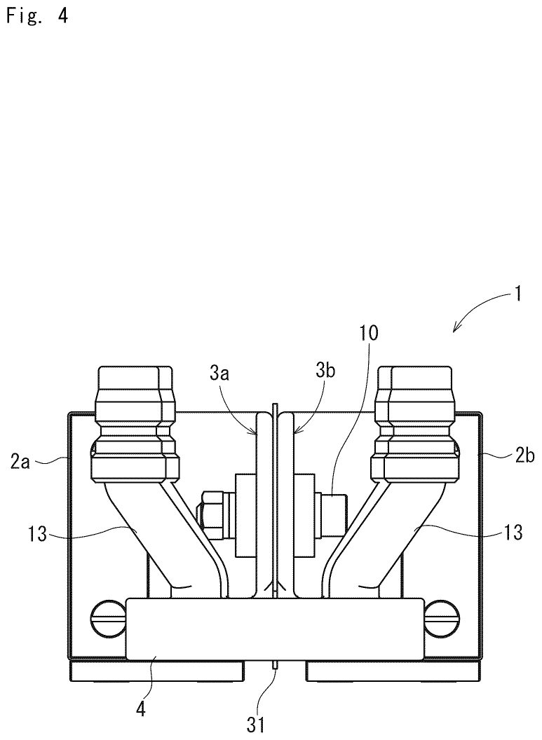

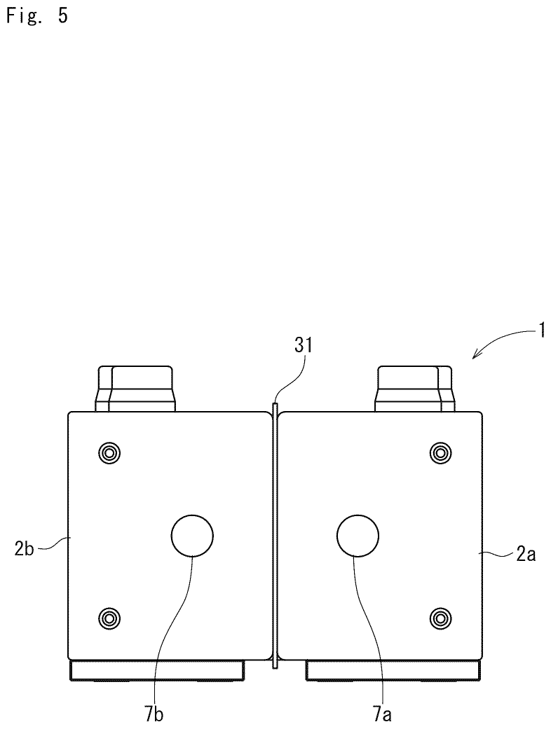

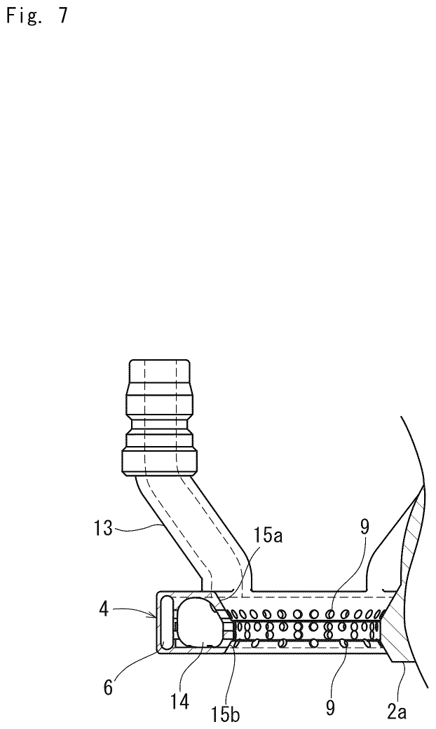

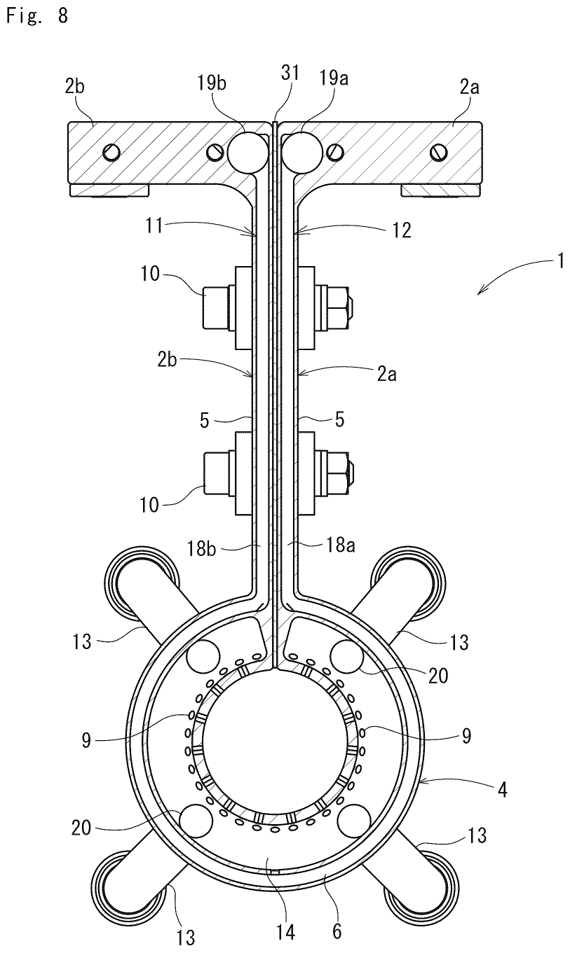

The following describes one embodiment of the heating coil according to the present invention in detail with reference to the drawings. FIG. 1 to FIG. 8 illustrate the heating coil, and a heating coil 1 is constituted of a coil body 21 integrally formed of copper alloy (high copper alloy), a sheet-shaped insulating plate 31 formed of synthetic resin (fluororesin) having an insulating property and heat resistance, and screw members (bolts and nuts) 10, 10. Then, the heating coil 1 has a size of longitudinal length (front-rear)×lateral length (width)×height32 300 mm×150 mm×100 mm (lengths of the largest portions in longitudinal side, lateral side, and height).

The coil body 21 is formed by a modeling method using a three-dimensional printer described later, and includes grounding portions 2a, 2b for contact with an electrode of a high-frequency power supply, a sequence of circumferential heating unit 4 configured to heat a material to be worked (workpiece) by induction heating, and supporting portions 3a, 3b configured to support the heating unit 4 at positions apart from the grounding portions 2a, 2b, respectively. Since the coil body 21 is formed by the modeling method using a three-dimensional printer, the whole coil body 21 has the same color, and the whole surface has the same roughness (surface roughness).

### Structure of Heating Unit

The heating unit 4 is configured to heat a material to be worked in its inserted state and has a ring (circular) shape with a base end separated to the left and right. An outer peripheral surface is vertically shaped, and an inner peripheral surface inclines to be smaller in diameter from an upper part to a lower part (tapered surface 15a). A portion in a lower end edge of the inner peripheral surface inclines to be larger in diameter from an upper part to a lower part (tapered surface 15b).

Furthermore, inside the heating unit 4, a cooling medium flow path 6 for cooling the heating unit 4 itself by flowing down a medium for cooling (such as water) and a second cooling medium flow path 14 for cooling a material to be worked after heating by flowing down a medium for cooling are provided in separate cavity shapes. The cooling medium flow path 6 is circumferentially provided outside so as to be adjacent to the second cooling medium flow path 14. Further, the cooling medium flow path 6 is formed in a cavity shape having a long elliptic cross-sectional surface in the up-down direction.

Meanwhile, the second cooling medium flow path 14 is formed in a cavity shape having an elliptic cross-sectional surface with an inner surface inclined so as to lie along the tapered surfaces 15a, 15b. Furthermore, a plurality of spray holes 9, 9 . . . having a circular-shaped (cylindrical) cross-sectional surface for spraying the medium for cooling to the material to be worked after heating are provided at equal intervals in multiplex concentric circles on the tapered surfaces 15a, 15b of the heating unit 4, and base ends of the spray holes 9, 9 . . . are communicated with the second cooling medium flow path 14.

The heating unit 4 has an upper surface and a lower surface that are horizontal, and two each of injection pipes 13, 13 . . . for injecting the medium for cooling from outside are disposed on the left and right of the upper surface so as to expand upward from base ends (lower ends) in a radiation direction (radiation direction from the center of the heating unit 4). Then, the portions separated to the left and right of the base end of the heating unit 4 are connected to respective distal ends (distal ends of lower end edges) of the left and right supporting portions 3a, 3b.

### Structure of Supporting Portion

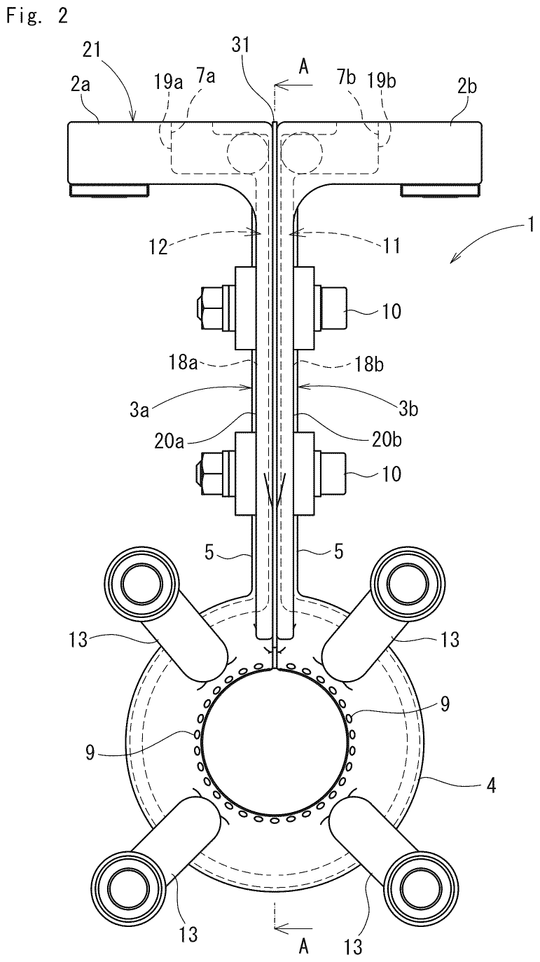

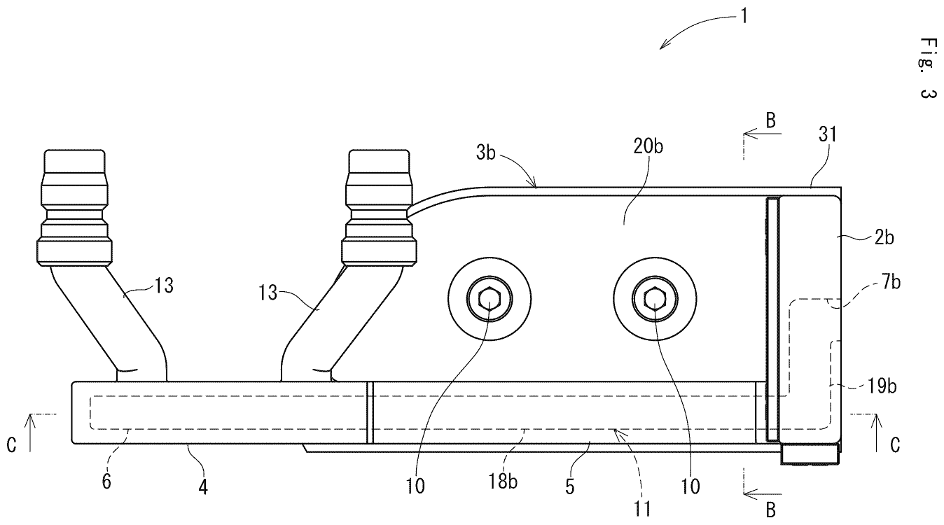

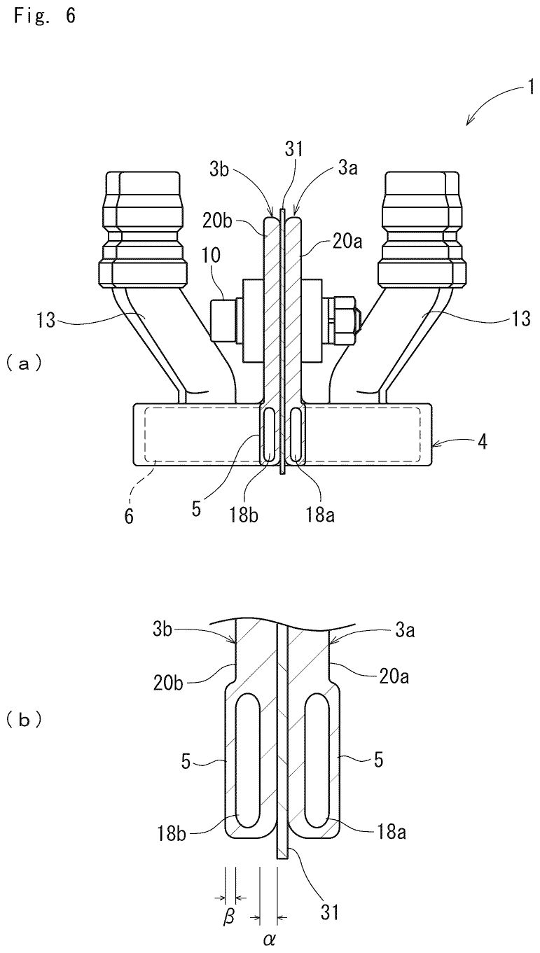

The respective supporting portions 3a, 3b are formed in a pair of left and right flat rectangular parallelepiped shapes (plate shapes), and disposed to be adjacent left and right at an interval of a predetermined distance (about 2 mm) with one-side plate surfaces facing one another. The respective supporting portions 3a, 3b have front upper portions chamfered in an arc shape. Then, as illustrated in FIG. 2, FIG. 3, and FIG. 6, inside close vicinities of lower end edges of the respective supporting portions 3a, 3b, cooling medium flow paths 18a, 18b are formed, respectively, so as to be communicated with the cooling medium flow path 6 inside the heating unit 4. The respective cooling medium flow paths 18a, 18b are formed in a long band-shaped cavity shape having a constant width along a front-rear direction and have a cross-sectional shape (the same shape as the cross-sectional surface of the cooling medium flow path 6 in the heating unit 4) having a long elliptic shape in the up-down direction (an elliptic shape with major axis=10 mm and minor axis=3.0 mm and having a portion with a constant width). Forming portions (bulging portions 5) of cooling medium flow-down paths 18a, 18b in the respective supporting portions 3a, 3b have a thickness of about 8.0 mm, and portions other than the forming portions of the cooling medium flow-down paths 18a, 18b (that is, contact portions 20a, 20b above the bulging portions 5) have a thickness of about 5.0 mm. In addition, in the forming portions of the cooling medium flow-down paths 18a, 18b in the respective supporting portions 3a, 3b, inner portions of the cooling medium flow-down paths 18a, 18b have a thickness (α in FIG. 6(b)) of 3.0 mm, and outer portions of the cooling medium flow-down paths 18a, 18b have a thickness (β in FIG. 6(b)) of 2.0 mm.

### Structure of Grounding Portion

The respective grounding portions 2a, 2b are formed in a pair of left and right flat rectangular parallelepiped shapes (plate shapes), and disposed to be adjacent left and right at an interval of a predetermined distance (about 2 mm) with inner side surfaces facing one another. Then, portions in close vicinities of inner end edges of the grounding portions 2a, 2b are continuous with base end edges of the left and right supporting portions 3a, 3b, respectively, and plate surfaces of the grounding portions 2a, 2b are perpendicular to plate surfaces of the supporting portions 3a, 3b, respectively. Further, a discharge port 7a and an injection port 7b that have a circular shape are drilled close to the centers of approximate centers (approximate centers in a height direction) of back surfaces of the grounding portions 2a, 2b, respectively. The discharge port 7a and the injection port 7b are communicated with cooling medium flow-down paths 19a, 19b formed vertically inside the respective grounding portions 2a, 2b. Furthermore, the cooling medium flow-down paths 19a, 19b inside the respective grounding portions 2a, 2b are connected to (communicated with) the cooling medium flow-down paths 18a, 18b inside the respective supporting portions 3a, 3b in the lower end edges of the respective grounding portions 2a, 2b.

### Structure of Cooling Medium Flow-Down Path

In the heating coil 1, as described above, not only inside the heating unit 4, but the cooling medium flow-down paths 18a, 18b for flowing down the medium for cooling are also formed inside the left and right supporting portions 3a, 3b, and the cooling medium flow-down paths 19a, 19b for flowing down the medium for cooling are also formed inside the left and right grounding portions 2a, 2b. Then, the cooling medium flow-down paths 18a, 18b and the cooling medium flow-down paths 19a, 19b are connected to (communicated with) a cooling medium flow-down path 6 inside the heating unit 4 in a sequence. That is, a cooling medium flow-down path (forward path) 11, which ranges from the injection port 7b of the grounding portion 2b via the cooling medium flow-down path 19b to the lower end edge of the grounding portion 2b and ranges via the cooling medium flow-down path 19b at the lower end edge of the right-hand supporting portion 3b to the cooling medium flow-down path 6 in the heating unit 4, is formed on the right side of the heating coil 1. Further, a cooling medium flow-down path (return path) 12, which ranges from the cooling medium flow-down path 6 in the heating unit 4 via the cooling medium flow-down path 18a at the lower end edge of the right-hand supporting portion 3a to the lower end edge of the grounding portion 2a and ranges via the cooling medium flow-down path 19a to a discharge port 7b of the left-hand grounding portion 2b, is formed on the left side of the heating coil 1.

Since the heating coil 1 is integrally formed by a three-dimensional printer, in the left and right cooling medium flow-down paths 11, 12 (that is, the cooling medium flow-down path 6 of the heating unit 4, the cooling medium flow-down paths 18a, 18b of the supporting portions 3a, 3b, and the cooling medium flow-down paths 19a, 19b of the grounding portions 2a, 2b), all bent portions and all coupling portions are formed in smooth curved shapes (curved shapes having a curvature radius of 5 mm or more), and a steeply bent shape is not formed. In addition, in the left and right cooling medium flow-down paths 11, 12, a seam or a level difference equal to or more than a predetermined height (1.0 mm) is not formed on an inner wall.

Furthermore, the sheet-shaped insulating plate 31 having a predetermined thickness (about 2.0 mm) is sandwiched between the left and right grounding portions 2a, 2b of the coil body 21, between the left and right supporting portions 3a, 3b, and between left and right base end portions of the heating unit 4. In this state, the left and right supporting portions 3a, 3b, and the insulating plate 31 are screwed together by the screw members (bolts and nuts) 10, 10 inserted through screw holes 8, 8. The screw members 10, 10 screw the supporting portions 3a, 3b and the insulating plate 31 together via bushes (not illustrated) made of synthetic resin (glass epoxy resin) having an insulating property and heat resistance and are configured to avoid conduction between the supporting portions 3a, 3b via the bolts.

### Manufacturing Method of Heating Coil

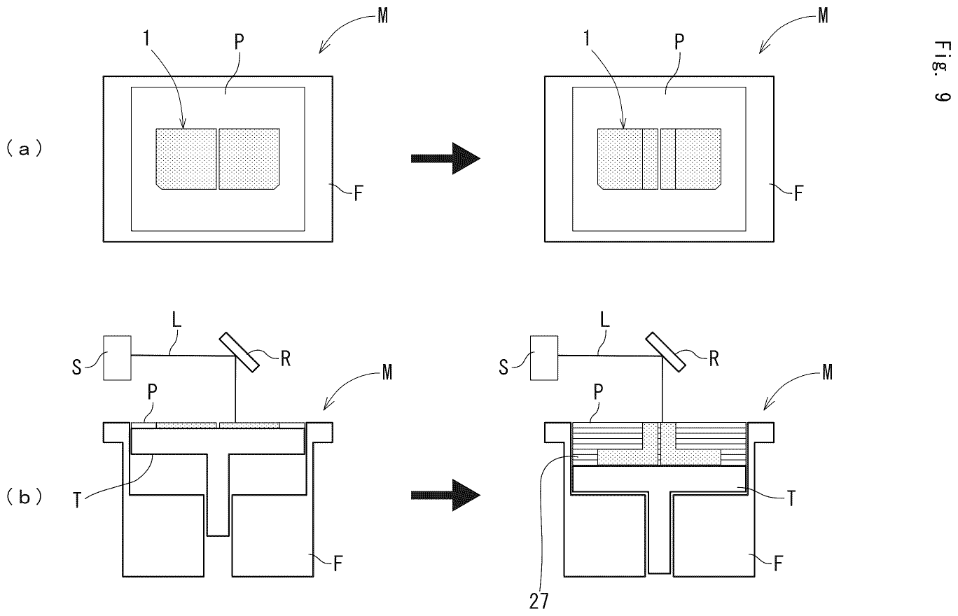

FIG. 9 illustrates a state of forming the heating coil 1 (the coil body 21), and a three-dimensional printer device M for forming the heating coil 1 includes a frame F having a rectangular parallelepiped recessed portion formed in the center, an elevating member disposed to be movable up and down with respect to the frame F, an irradiation means S configured to emit a laser L, a reflection means R configured to reflect the laser, and a driving means and the like (not illustrated) configured to move up and down the elevating member. Then, the elevating member is provided with a table T having approximately the same area as an opening portion of the recessed portion of the frame F.

In manufacturing the heating coil 1 with the three-dimensional printer device M, first, a powder of copper alloy (high copper alloy) is laid with a predetermined thickness (for example, 30 μm) on a surface of the table T of the elevating member at an elevated position (a copper powder is laid by an amount of a gap between the surface of the table T and a surface of an outer frame of the frame F). Then, the copper alloy powder is irradiated with the laser (fiber laser) L of a predetermined output in a predetermined shape to melt, cool, and solidify a part of the copper alloy powder, thereby forming a part of the heating coil 1.

After the formation of the part of the heating coil 1 as described above, the table T of the elevating member is moved down by a predetermined height (for example, 30 μm) by the driving means. Then, at the height position, the operation of “laying the copper alloy powder→irradiating the copper alloy powder with the laser L →cooling and solidifying the melted copper alloy (solidification by coagulation) on the upper side of the part of the previously formed heating coil 1” is repeated. Then, as described above, the operation of “moving down the table T of the elevating member→laying the copper alloy powder→irradiating the copper alloy powder with the laser L→cooling and solidifying the melted copper alloy” is repeated a predetermined number of times (for example, 5,000 times), thereby allowing integrally forming the heating coil 1 made of copper alloy.

### Use Method of Heating Coil

The heating coil 1 configured as described above can heat (harden) the material to be worked by grounding the left and right grounding portions 2a, 2b to electrodes, turning on an external power supply (high-frequency power supply) via the electrodes, and using an electromagnetic induction phenomenon in a state where the material to be worked is inserted into the inside of the sequence of circumferential heating unit 4. Further, by injecting a cooling medium (water) from the injection port 7b on the back surface of the right-hand grounding portion 2b, allowing it to flow through the cooling medium flow-down path 19b, the cooling medium flow-down path 18b in the right-hand supporting portion 3b, and the cooling medium flow-down path 6 in the heating unit 4, then allowing it to flow through the cooling medium flow-down path 18a in the left-hand supporting portion 3a and the cooling medium flow-down path 19b in the left-hand grounding portion 2a (that is, allowing the cooling medium to flow through the cooling medium flow-down path (forward path) 11 and the cooling medium flow-down path (return path) 12), and discharging the cooling medium from the discharge port 7a on the back surface of the left-hand grounding portion 2a, the heating unit 4, the supporting portions 3a, 3b, and the grounding portions 2a, 2b are efficiently cooled. This can avoid damage and the like due to melting of the insulating plate 31 with high precision. Furthermore, the material to be worked can be rapidly cooled by injecting the medium for cooling from the injection pipes 13, 13 . . . and spraying it from the spray holes 9, 9 . . . of the heating unit 4 to the material to be worked. Thus, by rapidly cooling the material to be worked after heating, a hardening process is performed on the material to be worked.

### Effect of Heating Coil

The heating coil 1 includes, as described above, the pair of plate-shaped grounding portions 2a, 2b for contact with the electrodes through which a high-frequency current is flowed, the pair of plate-shaped supporting portions 3a, 3b disposed to be perpendicular to the respective grounding portions 2a, 2b, and the sequence of circumferential heating unit 4 disposed to connect the distal ends of the supporting portions 3a, 3b to one another. The cooling medium flow-down paths 18a, 18b for flowing down a medium for cooling are formed inside the respective supporting portions 3a, 3b, and the cooling medium flow-down paths 18a, 18b are communicated with a cooling medium flow-down path 4 formed inside the heating unit 4 (that is, a sequence of cooling medium flow-down path is formed in the heating unit 4 and the supporting portions 3a, 3b). Accordingly, a portion maintained at a high temperature over a long time is not generated. Therefore, since the situation, such as dielectric breakdown caused by carbonization and/or deterioration of the insulating plate and damage due to stress concentration to a specific part, is less likely to occur, the heating coil 1 is excellent in durability and can undergo repeated heat treatment to a material to be worked over a long period of time even under a high output condition. In addition, in the heating coil 1, the portions (that is, contact portions 20) other than the forming portions (bulging portions 5) of the cooling medium flow-down paths 18a, 18b in the respective supporting portions 3a, 3b are thinner than the forming portions of the cooling medium flow-down paths 18a, 18b. Accordingly, the heating coil 1 can be inexpensively manufactured by reducing the material cost, is lightweight, and has excellent handling ability.

Further, the heating coil 1 is formed by the modeling method (that is, the partial welding lamination method of conductive material powder layer based on the three-dimensional data) using the three-dimensional printer device M. Accordingly, the heating coil 1 can be considerably easily manufactured even though the sequence of circumferential heating unit 4 has a complicated shape. Moreover, products having the same shape and the same characteristics can be efficiently manufactured with good reproducibility regardless of the skill of manufacturing workers. Furthermore, since the heating coil 1 is formed by the modeling method using the three-dimensional printer device M, a bonding portion by silver solder, as in a conventional heating coil, is not present. Accordingly, deformation does not occur even when the temperature rises due to continuous use, and heat treatment (hardening treatment) according to specifications can be performed over a long period of time.

Furthermore, in the heating coil 1, since the cooling medium flow-down paths 18a, 18b in the respective supporting portions 3a, 3b have a long flat-shaped cross-sectional surface (that is, a vertically elongated elliptic cross-sectional surface) in the plate surface direction of the respective supporting portions 3a, 3b, a sufficient amount of medium for cooling can be flowed down in the cooling medium flow-down paths 18a, 18b. Accordingly, the material to be worked and the heating coil 1 itself can be cooled highly efficiently.

In addition, in the heating coil 1, the forming portions (bulging portions 5) of the cooling medium flow-down paths 18a, 18b in the respective supporting portions 3a, 3b are formed such that inner portions of the cooling medium flow-down paths 18a, 18b where an applied high-frequency current easily flows are thicker than outer portions of the cooling medium flow-down paths 18a, 18b (that is, a α>β in FIG. 6). Accordingly, the situation, such as dielectric breakdown caused by carbonization and/or deterioration of the insulating plate 31 and damage due to stress concentration to a specific part, is extremely unlikely to occur, and very excellent durability can be exhibited.

Furthermore, as described above, in the heating coil 1, the cooling medium flow-down paths 19a, 19b for flowing down the medium for cooling are formed inside the respective grounding portions 2a, 2b, and the cooling medium flow-down paths 19a, 19b are communicated with the cooling medium flow-down paths 18a, 18b formed inside the supporting portions 3a, 3b (that is, a sequence of the cooling medium flow-down paths 11, 12 for flowing down the medium for cooling is formed inside the heating unit 4, the respective grounding portions 2a, 2b, and the respective supporting portions 3a, 3b). Accordingly, not only the heating unit 4 but also the respective grounding portions 2a, 2b and the respective supporting portions 3a, 3b are simultaneously cooled during heat treatment of the material to be worked, and a situation of being maintained at a high temperature over a long time is not generated. Therefore, since the situation, such as a dielectric breakdown caused by carbonization and/or deterioration of the insulating plate 31 and damage due to stress concentration to a specific part, does not occur, the heating coil 1 is excellent in durability, and can undergo the repeated heat treatment to the material to be worked over a long period of time even under a high output condition.

### Modification of Heating Coil

The heating coil according to the present invention is not limited to the above-described aspect of the embodiment in any way, and the configuration, such as a material, and shapes and structures of the grounding portions, the supporting portions, the heating unit, the slit-like portions (sinking portions), and the cooling medium flow-down paths, can be appropriately changed as necessary without departing from the gist of the present invention.

For example, the heating unit of the heating coil is not limited to one having a simple circular shape as in the above-described embodiment. However, the heating unit can be changed to one having a rectangular circumferential shape in plan view, one formed by horizontally arranging divided circular bodies or circumferential bodies one above the other and coupling them with a vertical columnar body (columnar body extending in the up-down direction), one having a shape in which arc-shaped left and right upper circumferential heating bodies disposed on the upper side and an arc-shaped lower circumferential heating body disposed on the lower side are coupled at close vicinities of respective outer end edges with two vertical columnar heating bodies, or the like.

Furthermore, the heating unit is not limited to one in which the cooling medium flow-down path for cooling the heating unit itself after heating and the second cooling medium flow-down path for cooling a material to be worked after heating are separately provided in the heating unit as in the above-described embodiment. However, the heating unit may be one including a single cooling medium flow-down path for cooling the heating unit itself after heating in the heating unit. When two types of cooling medium flow-down paths are provided as in the above-described embodiment, there is an advantage that cooling of the material to be worked after heating and cooling of the heating unit itself can be performed more efficiently. Additionally, the heating coil is not limited to one including a single cooling medium flow-down path (for cooling mainly the heating coil) such that the cooling medium injected from the grounding portion on one side flows through the supporting portion on the same side, reaches the heating unit, then flows through the supporting portion on the opposite side, and is discharged from the grounding portion on the opposite side as in the above-described embodiment. However, the heating coil may be, for example, one in which the cooling medium flow-down path is divided into left and right paths.

In the supporting portions, all the portions other than the forming portions of the cooling medium flow-down paths need not be thinner than the forming portions of the cooling medium flow-down paths as in the above-described embodiment. However, the supporting portions may have portions having a thickness equal to or more than the forming portions of the cooling medium flow-down paths for the purpose of reinforcement. In addition, the cooling medium flow-down paths in the supporting portions are not limited to those having a vertically elongated elliptic cross-sectional surface as in the above-described embodiment but may be one having a cross-sectional surface having a shape other than a vertically elongated elliptic shape, such as a thick arc shape extending up and down.

In addition, the heating coil according to the present invention is not limited to one in which the insulating plate made of fluororesin (PTFE, PFA, FEP, ETFE, PCTFE, ECTFE, PVDF) insulates between the pair of grounding portions and between the pair of supporting portions as in the above-described embodiment, and can be changed to, for example, one in which the insulating plate made of another synthetic resin having an insulation property and heat resistance, such as polyacetal (POM), polyphenylene sulfide (PPS), and polyetheretherketone (PEEK), insulates between the pair of grounding portions and between the pair of supporting portions.

In addition, the heating coil according to the present invention is not limited to the above-described aspect of the embodiment in any way on the shape and size of the entire heating coil, the shape of the heating unit (the shape of the entire heating unit, the angle of the tapered surface opposed to a material to be worked, and the like), the shape and size of the grounding portions, the shape and size of the supporting portions, the type (material) and thickness of the sheet-shaped insulating plate, the number of bolts for clamping the insulating plate. However, the heating coil can be appropriately changed according to the shape and the like of a workpiece subjected to a hardening process.

### INDUSTRIAL APPLICABILITY

The heating coil according to the present invention provides the excellent effects as described above, and therefore, can be appropriately used as a member for heating a material to be worked using electromagnetic induction.

### DESCRIPTION OF REFERENCE SIGNS

1 . . . Heating coil
2a, 2b . . . Grounding portion
3a, 3b . . . Supporting portion
4 . . . Heating unit
5 . . . Bulging portion (forming portion of cooling medium flow-down path)
6 . . . Cooling medium flow-down path
7a . . . Discharge port
7b . . . Injection port
11 . . . Cooling medium flow-down path (forward path)
12 . . . Cooling medium flow-down path (return path)
13 . . . Injection pipe
14 . . . Second cooling medium flow-down path
18a, 18b . . . Cooling medium flow-down path
19a, 19b . . . Cooling medium flow-down path
20a, 20b . . . Contact portion

1. A heating coil used for a high-frequency heater configured to heat a material to be worked using electromagnetic induction by a high-frequency current, wherein
the heating coil for a high-frequency heater is integrally formed by a modeling method of repeating laying, melting, solidifying, and laminating of a powder containing a conductive material based on three-dimensional data, or a modeling method of laminating a melted conductive material based on three-dimensional data, and
the heating coil comprises:
a pair of plate-shaped grounding portions for contact with an electrode through which a high-frequency current is flowed;
a pair of plate-shaped supporting portions disposed to be perpendicular to the respective grounding portions; and
a sequence of circumferential heating unit disposed to connect distal ends of the supporting portions to one another, wherein
a cooling medium flow-down path for flowing down a medium for cooling is formed inside each of the supporting portions, and the cooling medium flow-down path is communicated with a cooling medium flow-down path formed inside the heating unit, and
a portion other than a forming portion of the cooling medium flow-down path in each of the supporting portion is thinner than the forming portion of the cooling medium flow-down path.

2. The heating coil for a high-frequency heater according to claim 1, wherein
the cooling medium flow-down path in each of the supporting portions has a long flat-shaped cross-sectional surface in a plate surface direction of each supporting portion.

3. The heating coil for a high-frequency heater according to claim 1, wherein
in the forming portion of the cooling medium flow-down path in each of the supporting portions, an inner portion of the cooling medium flow-down path is formed thicker than an outer portion of the cooling medium flow-down path.

4. The heating coil for a high-frequency heater according to claim 1, wherein
a cooling medium flow-down path for flowing down a medium for cooling is formed inside each of the grounding portions, and the cooling medium flow-down path is communicated with the cooling medium flow-down path formed inside the supporting portion.
